(19) United States
(12) Patent Application Publication
(10) Pub. No.: US 2016/0256880 A1
(43) Pub. Date: Sep. 8, 2016

(54) PRESSURE WASHING SYSTEM WITH SELECTIVE FLUID INJECTION FEATURES

(71) Applicant: Karcher North America, Inc., Denver, CO (US)

(72) Inventors: Paul W. Linton, Camas, WA (US); John Philip Fortes, Vancouver, WA (US)

(21) Appl. No.: 15/061,773

(22) Filed: Mar. 4, 2016

Related U.S. Application Data
(60) Provisional application No. 62/128,609, filed on Mar. 5, 2015.

(51) Int. Cl. B05B 7/32; B05B 12/00

(52) U.S. Cl. CPC B05B 7/32; B05B 12/004; B05B 12/002

(57) ABSTRACT

A system for pressurizing and dispensing one or more fluids is provided. A chemical or cleaning agent is connected to a high pressure pump to entrain a first volume or flow of fluid with a cleaning agent. The cleaning agent or chemical is applied to the system and flow path of the system at various different locations. Spray guns and washing wands for use with various systems are also provided.

This U.S. Non-Provisional Patent Application claims the benefit of priority from U.S. Provisional Patent Application Ser. No. 62/128,609, filed Mar. 5, 2015, the entire disclosure of which is hereby incorporated by reference in its entirety.

### FIELD OF THE DISCLOSURE

The present disclosure generally relates to pressure washing and fluid dispensation systems. More specifically, embodiments of the present disclosure relate to high pressure washing systems with means for injecting one or more additional fluids into a stream of fluid of an existing fluid flow.

### BACKGROUND

Existing systems and devices that contemplate providing a cleaning chemical or fluid within a water-based solution inject the chemical or chemicals in a pre-mixed manner wherein fluids directed through a pump, coil, and/or heating element already comprise a potentially harmful chemical. Such systems subject sensitive or expensive system components to the chemical which may cause harm to the system and reduce overall lifespan of the device or system.

### SUMMARY

Accordingly, there has been a long-felt and unmet need to provide a system for pressure washing and dispensing fluids that allows injections of fluids and chemicals into a system that is already under pressure. There is a further need to provide injection and entrainment of fluids and chemicals into a pre-existing fluid line wherein a pressure washer pump or coil is not subjected to such chemicals.

Known pressure washing systems generally use one of two methods for injecting a chemical into a fluid line. Either a chemical is siphoned into the pressure washer pump using the vacuum created by the pump, and the combination of water and chemical then travel through a hose, gun, and spray wand to a surface to be cleaned, or a downstream chemical injector is provided in the discharge line which creates a Venturi that siphons chemical(s) into a discharge line which then mixes with the water and is carried through a hose, gun, and/or wand to the surface to be cleaned. Such a system will only siphon a chemical or fluid when the pressure in the discharge line is reduced by at least 35% of the operating pressure. These systems thus only apply chemicals or fluids at low pressure.

Embodiments of the present disclosure provide for high-pressure chemical and fluid injection into a system during operation of the system. Various embodiments comprise a separate unique injection pump that injects a chemical or fluid into a pressure washer discharge line. An operating pressure is maintained which allows an operator to clean with at least one entrained chemical or fluid at high pressure(s). Such systems and methods of injecting a chemical or fluid into the system prevents chemicals from coming in contact with the pressure washer pump, heating coil, and other potentially sensitive systems of a pressure washer. Harsh or corrosive chemicals that may have been damaging to the pressure washer pump and coil can be used in the cleaning process. The time required to clear the pump and/or coil of chemicals when changing from soap to rinse operations (for example) is reduced due to the chemical being injected downstream of the pump or coil and thus impacting less of the system while still providing the desired cleaning advantages. The unique injection pump is capable of handling higher viscosity ultra-concentrated chemicals.

In one embodiment, a system for dispensing a fluid to clean an object is provided, the system comprising a first fluid source, the first fluid source in communication with a first pump and the first pump comprising an outlet. The outlet of the first pump comprising a fluid conduit, the fluid conduit interconnected to the first pump at a first end and a fluid dispensing device at a second end. A second fluid source is provided, the second fluid source interconnected to the fluid conduit and adapted to inject a fluid into the fluid conduit. The second fluid source comprises a predetermined quantity of fluid and a second pump is provided to selectively dispense fluid from the second fluid source and entrain a first fluid from the first fluid source with a second fluid from the predetermined quantity of fluid.

In various embodiments, a novel dispensing wand or spray gun is provided. Spray guns and dispensing wands of the present disclosure comprise chemical and fluid injection capabilities wherein such devices are provided to receive a first fluid through a first fluid inlet and a second fluid through a second fluid inlet and provides mixing capabilities for at least two fluids prior to dispensation from a gun or wand. Such spray guns or wands may be provided in combination with additional system features and devices as described herein, or may be provided as stand-along components. In certain embodiments, a chemical container is provided for connection to the wand, container contents are forced out by means of either water pressure from the pressure washer, or from air pressure created by a separate hand operated pump built into a cylinder provided on or in the gun.

U.S. Pat. No. 4,591,071 to Johnson, which is hereby incorporated by reference in its entirety, discloses a gun for dispensing a continuous stream of fluid. A pressurization pump is provided and integrated with the gun, the pressurization pump being manually operable and useful for pressurizing an on-board volume of water that may be dispensed via a trigger mechanism and an outlet nozzle. Such features are contemplated for use in embodiments of the present disclosure, wherein a spray gun comprises one or more on-board storage vessels for a liquid or chemical to be dispensed from the gun.

In various embodiments, a chemical or fluid is drawn out of a cylinder provided in fluid communication with the spray gun and travels through a tube or conduit that exits near a high pressure spray nozzle. A chemical exiting the conduit entrains with another fluid exiting the high-pressure nozzle which then mixes together to apply the chemical to the surface under high pressure.

In various embodiments, spray guns and dispensing wands are capable of internal pressures up to approximately 5,000 PSI, dispense liquids of various viscosities and temperatures, provide precision metering for high accuracy of dispensing, and/or comprise a DC motor driven piston pump with variable speed control.

In certain embodiments, a dispensing cylinder is provided on or contained within a spray wand or gun that provides instantaneous transition from a soap or chemical dispensing operation to a rinse or water dispensation operation and prevents chemical waste. The device(s) apply chemical under low or high pressure. The present disclosure contemplates providing a spray gun with a pressurized liquid from a pressure washer, as well as providing a spray gun with a lower and manually-generated pressure. Such lower pressures may be provided by a user-operated pump disposed on the gun, and a pressure container for such embodiments may comprise either a metal or molded plastic vessel, or combinations thereof.

In various embodiments, the present disclosure provides a system for injecting and/or metering a concentrated or ultra-concentrated cleaning chemical into a fluid flow path. The fluid flow path may comprise a water or water-based fluid flow path comprising a high pressure generated by one or more pumps or pressure washer devices. An additional fluid or chemical is provided to the fluid flow path at a location downstream of the pump or coil of a pressure washer or compressor by a peristaltic or similar pump, which is controlled by a rheostat or similar device in certain embodiments.

Metering and measuring of concentrates into a system and in accordance with the present disclosure provides an accurate method and system of dispensing concentrates or fluids and a more cost-effective system. Systems of the present disclosure also contemplate and provide a convenient and cost-effective system for packaging and providing concentrates and chemicals.

In various embodiments a motor is provided to power a pump to inject or entrain a second fluid into a first fluid flow path. In one embodiment, a pump (e.g. peristaltic pump) comprising a DC motor is provided for direct chemical injection and wherein a current provided to the DC motor is selectively adjustable via a rheostat or similar device in order to selectively and accurately control a fluid flow rate of the second fluid into the first fluid flow path. In certain embodiments, a rheostat and pump combination allows for direct injection of fluid into a line without the need for a restriction or Venturi in the line. The lack of such a restriction in the line reduces overall stress on the system and extends the life of the system and devices.

In various embodiments of the present disclosure, direct injection of a chemical or fluid into a fluid discharge line is enabled wherein the direct injection is precise and is provided downstream of a pump or coil, thus avoiding exposure of the pump or coil to harsh or corrosive chemicals.

In certain embodiments, high-pressure chemical injection is provided to inject a high-pressure chemical into a fluid flow path downstream of certain components of the system. In such embodiments, corrosive chemicals can be entrained into a fluid flow path without subjecting a pressure washer pump or coil to the chemical(s).

Various embodiments of the present disclosure contemplate a high pressure injection of a chemical or cleaning fluid into a fluid line, the injection utilizing a positive displacement piston pump to inject chemical into a high pressure discharge line. A discharge pressure, which may operate at between approximately 1,000 to 5,000 psi in certain embodiments, is maintained for applying chemical under pressure to a surface to be cleaned. High pressure chemical injection according to embodiments of the present disclosure eliminates harsh chemicals from coming in contact with a pump and/or coil of a hot water pressure washer.

In various embodiments, a low pressure chemical injection system is provided that utilizes a peristaltic or diaphragm pump which injects a chemical or cleaning fluid into a high pressure pump inlet line. Low pressure injection pumps of the present disclosure normally operate at between approximately 5 and 50 psi, although no limitation with respect to pressure ratings are provided herewith. Low pressure injection pumps eliminate the need for the high pressure pump to create a vacuum to siphon a chemical. A low pressure injection pump is able to maintain a more accurate rate of dispensing ultra concentrate chemical into an inlet water line of a high pressure pump. In certain embodiments, low pressure chemical injection allows the chemical to come in contact with the high pressure pump and coil.

In one embodiment, a spray gun for dispensing a fluid is provided. The spray gun comprises a first fluid inlet operable to receive a supply of first fluid from a source. A first fluid outlet is operable to dispense the first fluid from the gun. A first fluid conduit extends between the first fluid inlet and the first fluid outlet and at least partially defines a fluid flow path. A valve is provided in a fluid flow path between the first fluid inlet and the first fluid outlet, the valve being operable to selectively prevent a fluid from exiting the first fluid outlet. A first trigger is interconnected to and is operable to activate the valve. A fluid storage container is provided that comprises an internal volume, a second fluid inlet and a piston, the piston being operable to apply a pressure to a stored fluid provided within the internal volume and to dispense the stored fluid through the second fluid outlet. A second fluid conduit extends from the internal volume and comprises a second fluid outlet, the second fluid outlet provided proximal to the first fluid outlet and is operable to dispense the stored fluid into the first fluid after the first fluid has exited the first fluid outlet and such that the stored fluid is entrained with the first fluid to aid in cleaning operations.

In another embodiment, a spray gun for dispensing a fluid is provided. The spray gun comprises a first fluid inlet operable to receive a supply of first fluid from a source, a first fluid outlet operable to dispense the first fluid from the gun, a fluid conduit extending between the first fluid inlet and the first fluid outlet and at least partially defining a fluid flow path. A valve is provided in a fluid flow path between the first fluid inlet and the first fluid outlet, the valve being operable to selectively prevent a fluid from exiting the first fluid outlet. A first trigger is interconnected to and operable to activate the valve. A fluid storage container is secured to the spray gun, the fluid storage container comprising an internal volume, a second fluid inlet, a second fluid outlet, wherein the spray gun is operable to apply a pressure to a stored fluid provided within the internal volume and to dispense the stored fluid through the second fluid outlet. The second fluid outlet is operable to selectively dispense a fluid from the fluid storage container to be entrained with the supply of first fluid.

In another embodiment, a wand for dispensing a fluid is provided, the wand comprising a first fluid inlet operable to receive a supply of first fluid from a source, and a first fluid outlet operable to dispense the first fluid from the gun. A first fluid conduit extends between the first fluid inlet and the first fluid outlet and at least partially defines a fluid flow path. A valve is provided in a fluid flow path between the first fluid inlet and the first fluid outlet, the valve being operable to selectively prevent a fluid from exiting the first fluid outlet. A first trigger is interconnected to and operable to activate the valve. A fluid storage container is secured to the wand, the fluid storage container comprising an internal volume, a second fluid inlet, a second fluid outlet, and a second fluid conduit extending between the second fluid inlet and the second fluid outlet. The second fluid conduit is operable to selectively dispense a fluid from the fluid storage container to be entrained with the supply of first fluid.

In various embodiments, a fluid storage container for housing and dispensing a chemical or fluid to a first fluid is provided. In certain embodiments, the fluid storage container is provided in combination with a gun, lance or wand and the components generally comprise a single device wherein removal of components is difficult or impossible. In alternative embodiments, the fluid storage container and related dispensing features are provided as add-on components that may be connected to a pre-existing pressure washing gun or lance as an aftermarket-type device. In various embodiments, the fluid storage container and related components are referred to as being “secured” to the gun, lance or wand. It will be recognized, however, that the term “secured” as used herein is intended to refer to various different methods and devices for securing or connecting components. The term “secured” is thus contemplated as referring to a temporary securing of components (such as through fasteners, clamps, ties, etc.) as well as a permanent securing of components (such as permanent fasteners, co-molding of parts, etc.).

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

FIG. 1 is a perspective view of a chemical injection system according to one embodiment of the present disclosure.

FIG. 2A is a perspective view of a chemical injection system according to one embodiment of the present disclosure.

FIG. 2B is a perspective view of a component of the system according to the embodiment of FIG. 2A.

FIG. 3A is a perspective view a pressure washing device according to one embodiment of the present disclosure.

FIG. 3B is a detailed view of a component of FIG. 3A.

FIG. 4 is a perspective view of a fluid dispensing device according to one embodiment of the present disclosure.

FIG. 5 is a perspective view of a fluid dispensing device according to one embodiment of the present disclosure.

FIG. 6 is a perspective view of a fluid dispensing device according to one embodiment of the present disclosure.

FIG. 7 is a cross-sectional elevation view of a fluid dispensing device according to one embodiment of the present disclosure.

FIG. 8 is a cross-sectional elevation view of a fluid dispensing device according to one embodiment of the present disclosure.

FIG. 9 is an exploded perspective view of the fluid dispensing wand according to an embodiment of the present disclosure.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

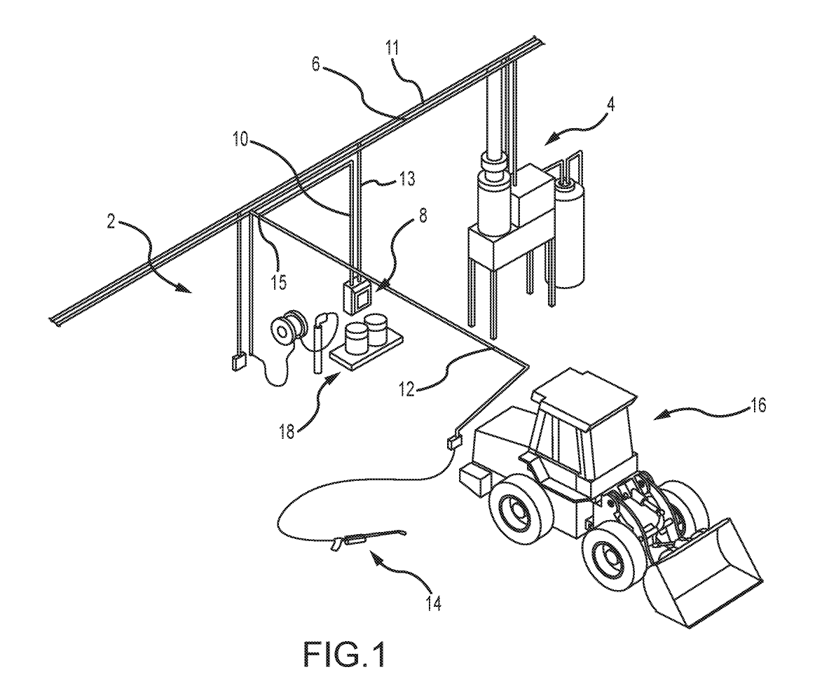

FIG. 1 is a perspective view of a fluid dispensing system 2 according to one embodiment of the present disclosure. As shown in FIG. 1, the system 2 comprises a fluid dispensing or pressure washing system for providing a pressurized spray to clean various objects. Although FIG. 1 depicts a generally stationary system integrated into a building or structure, it will be recognized that the present disclosure is not limited to such arrangements. Indeed, it is contemplated that various features and devices as shown and described herein may be provided and employed in mobile or semi-mobile arrangements and devices. The system 2 comprises a pressure washer 4. The term “pressure washer” as used herein refers to various pressure or power washing devices comprising a motor or engine that drives a fluid pump. No limitation is provided herein with respect to power, pressure, flow-rate, velocity or similar attributes of a pressure washer, as one of ordinary skill in the art will recognize that various different devices may be employed within the scope and spirit of the present disclosure.

A pressure washer 4 comprises a fluid outlet line 6 for directing a pressurized fluid to a gun 14, wand, or other dispensing means. The system further comprises an injection pump 8, described in more detail herein, for injecting an additional fluid or chemical into a flow of fluid in the fluid outlet line 6. In the depicted embodiment, an injection pump 8 is provided externally to the pressure washer 4, and is in fluid communication with an outlet line 6 of the pressure washer but not with the pressure washer 4. As shown, the injection pump 8 is adapted to convey a fluid (e.g. cleaning chemical, etc.) through an injection pump outlet line 10. The injection pump outlet line 10 is interconnected to the fluid outlet line 6 at a union 15 downstream of the pressure washer 4 such that a fluid or chemical from the injection pump 8 may be entrained into a fluid from the pressure washer 4. The combined fluid is conveyed to a dispensation device 14 via a conduit 12, wherein the conduit 12 is provided for conveying at least one of a fluid from the pressure washer 4 and a fluid from the injection pump 8. In the depicted embodiment, the injection pump 8 comprises an additional fluid conduit 13 for supplying fluid to one or more supply lines 11 that may be directed to other components or features (not shown in FIG. 1).

The system 2 provides for dispensation of a liquid from a pressure washer 4, an injection pump 8, or a combination of fluids from the pressure washer 4 and injection pump 8 to be dispensed and clean various objects 16. Embodiments of the present disclosure provide for various advantages including, for example, the addition and injection of a cleaning chemical downstream of the pressure washer 4 (i.e. by the injection pump 8) wherein the cleaning chemical is not placed in contact with components of the pressure washer 4, such as a pump or heating coil provided within the pressure washer 4. Rather, fluids, chemicals, and the like may be injected or entrained into a flow path 12 downstream of such components, reducing corrosion and stress on the pressure washer 4 and allowing for a quicker transition from a chemical-dispensing mode of the system 2 to a rinse or water-only dispensation mode of the system. In the embodiment shown in FIG. 1, only a portion of a fluid conduit 12 is impacted by a cleaning chemical, and a remaining portion comprising the fluid outlet line 6 of the pressure washer is only subjected to clean fluid (e.g. water). In such embodiments, a smaller portion of the fluid dispensing line 12 needs to be cleared of fluids or chemicals to convert to a rinse mode.

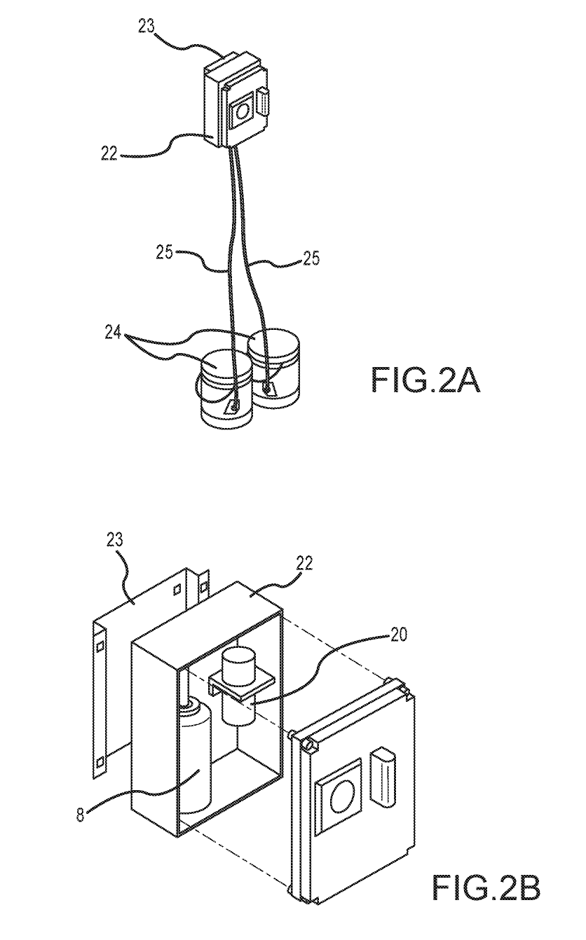

FIG. 2A is a detailed view of an injection pump 8 according to one embodiment of the present disclosure. The injection pump 8 may comprise a high pressure piston pump. Current or power to the pump 8 is selectively controlled by a metering rheostat 20 as shown in FIG. 2B. The rheostat 20 provides for variable control of the pump 8 and is thus capable of controlling flow rate of a fluid from the pump. FIG. 2B provides a detailed view of the embodiment of FIG. 2A wherein an injection pump 8 and rheostat control 20 are provided within a housing 22 or control unit. The pump 8 and rheostat 20 are operable to draw fluid from one or more containers 24 for injecting the fluid into a system 2. Fluid conduits 25 are provided to draw fluid from the containers 24.

As shown in FIG. 2A, the containers 24 comprise plastic buckets or barrels that may be easily refilled, transported, replaced, etc. It will be recognized, however, that the present disclosure is not limited to any particular vessel, container, or receptacle for chemicals or fluids to be injected into the system. The pump and housing 22 preferably comprise a wall-mounted unit comprising a bracket 23. Such a system is well suited for use with system as illustrated in FIG. 1, as well as other embodiments.

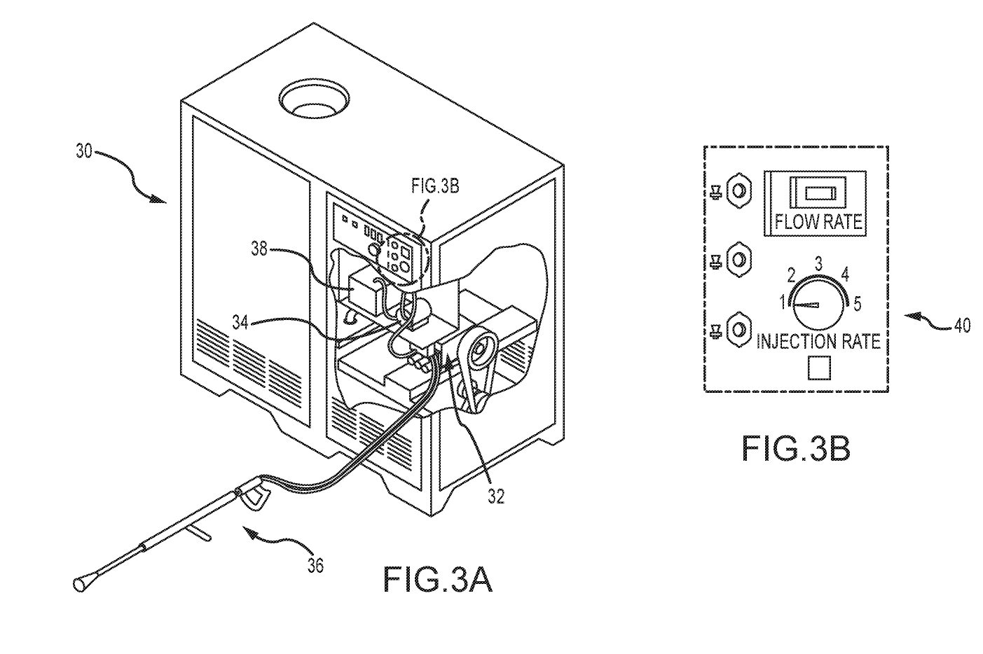

FIGS. 3A-3B depict one embodiment of the present disclosure wherein a pump is provided to inject a chemical or fluid into a pump. As shown in FIG. 3A, a pressure washer 30 is provided, the pressure washer 30 comprising a high pressure water pump 32 and a secondary pump 34 for pumping fluid. The secondary pump 34, which in certain embodiments comprises a fluid injection pump of the peristaltic variety, is operable to pump a fluid or chemical directly into the high pressure water pump 32 or to a conduit provided downstream of the pump 32 where the fluid or chemical is mixed with an additional fluid (e.g. water) before being dispensed through a spray wand or gun 36. A chemical or fluid is stored on-board in a chemical container 38, which is preferably accessible from an exterior of the device 30 for at least one of refilling and replacement. In the depicted embodiment, the secondary pump 34 directly injects a chemical into the high pressure water pump 32. In alternative embodiments, however, it is contemplated that a chemical from the secondary pump 34 and the high pressure water pump 34 are mixed or combined downstream of the high pressure water pump 32.

In a preferred embodiment, the secondary pump 34 comprises a peristaltic pump with a DC motor that is selectively and variably controlled by a control means 40. A control means 40 is shown in greater detail in FIG. 3B, and is generally accessible to a user from an exterior portion of the pressure washer 30. The control means, which comprises a variable speed rheostat in certain embodiments, and the DC motor of the pump allows for near infinite control of the adjustment of a chemical being injected into the high pressure water pump 32. Additionally, the provision of the secondary pump 34 as an injection pump eliminates the need to provide a restriction in the pump inlet in order to draw in a fluid or chemical. The lack of need for this restriction reduces stress on the pump 32 and provides for longer device life. For example, the seals provided in high pressure water pump 34 are subjected to reduced stress and last longer than those of prior art devices. The embodiment provided in FIGS. 3A-3B is preferably used with chemicals that generally do not harm the components of the high pressure water pump 34.

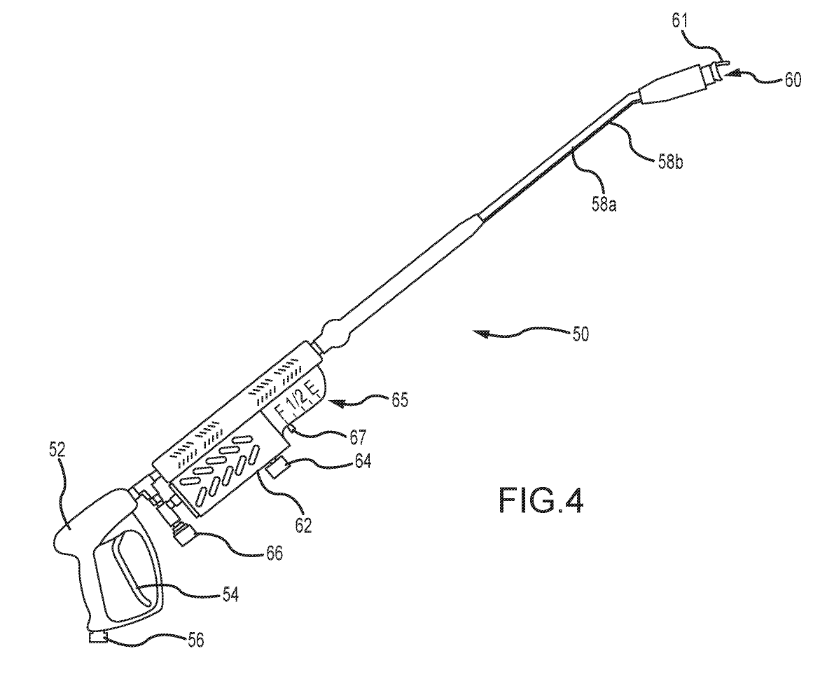

FIG. 4 is a perspective view of a dispensing wand 50 according to one embodiment of the present disclosure. As shown, the dispensing wand 50 comprises a shut-off gun portion 52 including a trigger 54 and a fluid inlet 56. The trigger 54 is operable to selectively dispense a fluid from the fluid inlet 56 through at least one of a first elongate conduit 58a and a second elongate conduit 58b, and a first fluid outlet 60 which may comprise a nozzle. The first fluid outlet 60 may comprise various different nozzles based on a desired application. The dispensing wand 50 according to various embodiments further comprises a fluid storage container or tank 62 for containment of a fluid or chemical. In certain embodiments, the fluid storage container 62 comprises an internal piston (not shown in FIG. 4). In various embodiments, the piston is actuated by water pressure from the shut off gun which forces the chemical in the container out through a second elongate conduit a secondary outlet 61. The fluid or chemical provided in the container 62 may be directed through one or both of the first 58a and second 58b conduits, or through a third conduit, such as flexible hose provided with the device 50. The device of FIG. 4 is depicted as comprising a primary conduit 58a for directing fluid, such as water, and a secondary conduit 58b for directing contents of the fluid storage container 62. It is contemplated, however, that the device of FIG. 4 and other embodiments comprises a wand with a plurality of pressurized water conduits. In certain embodiments, a wand is provided with variable pressure capabilities and wherein either or two (for example) water conduits may be selected. In such embodiments, the conduit for directing fluid from the fluid storage container 62 may be considered a third conduit. No limitation with respect to the number of conduits extending toward a dispensing end of the device is provided herewith. Additionally, the use of the term “second conduit” with respect to element 58b is not intended to be limiting.

As shown in FIG. 4, the secondary outlet 61 is provided proximal to the first fluid outlet 60. Chemicals or fluid exiting the secondary outlet 61 are thus mixed or entrained with the flow of fluid from the first fluid outlet 60 after both fluids have been ejected from the device 50, at least in the embodiment depicted in FIG. 4. In alternative embodiments, the fluid storage container 62 comprises means for injecting a chemical into a flow of water just prior to the combined fluid exits the device 50. In various embodiments, the system thus provides for an efficient means for injecting a chemical into a fluid flow and quick transitioning from a “rinse” (e.g. water only) to a “soap” (e.g. water and chemical combination) operation or mode of use. The embodiment of FIG. 4 further prevents or avoids contact between a cleaning chemical and a pump or coil of a system (not shown in FIG. 4). Chemicals may be applied and dispensed under high or low pressure operations.

The device of FIG. 4 further comprises a valve 66 which controls the rate of pressure exerted onto the piston inside of container 62. The exerted pressure onto the piston controls the rate of chemical flow to the second outlet 61. The valve 66 preferably comprises a manually adjustable valve for selectively controlling the amount of fluid diverted into the internal volume of the container 62 and a corresponding amount of pressure applied to a fluid or chemical stored within the fluid storage container 62. Chemicals or cleaning fluids may be filled directly into the fluid storage container 62 by a primary inlet 64 including a sealing cap. Where greater mobility and ease of chemical dispensing is desired, the fluid storage container 62 provides for on-board storage of a chemical to be dispensed with a fluid from the dispensing wand 50. Embodiments of the present disclosure contemplate providing pre-existing ultra-concentrate containers with the dispensing wand 50. Such contemplated devices include, but are not limited to the commercially available Nexus system by U.S. Chemical.

Additionally, in alternative embodiments, it is contemplated that the fluid storage device(s) of the present disclosure comprise a bag or bladder provided as an insert. The bag or bladder preferably comprises a replaceable volume of fluid or chemical. Fluid applied or injected into an internal volume of the fluid storage container applies a hydrostatic force of pressure to the bag or bladder, and contents thereof of ejected and allowed to be dispensed from the device.

As further shown in FIG. 4, the device 50 comprises a gauge 65 with an indicator 67. The indicator 67 and gauge 65 provide visual indicia to a user related to the amount of fluid or chemical stored within the fluid storage container 62. The visual indicia is preferably directly connected to the piston provided within the fluid storage container, such that the movement of the piston translates the visual indicia and provides feedback to user.

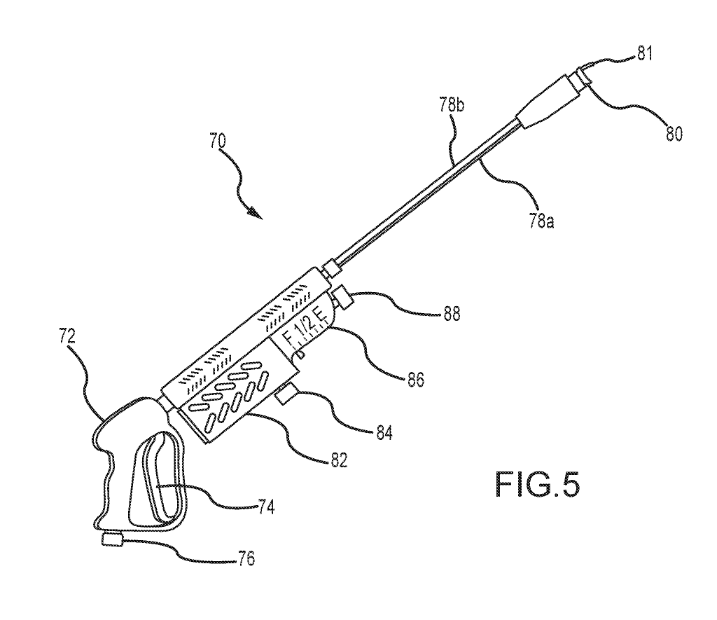

FIG. 5 is a perspective view of a dispensing wand 70 according to another embodiment of the present disclosure. The dispensing wand 70 comprises various features as shown and described with respect to the embodiment of FIG. 4 including, for example, a shut off gun 72 with a trigger 74 and a first fluid inlet 76, at least one fluid conduit 78a and a first fluid outlet 80. The dispensing wand 70 also comprises a fluid storage container 82 for storing and injecting a chemical or fluid stored in the fluid storage container 82 into a flow of water exiting the fluid outlet 80. In the depicted embodiment, the fluid storage container 82 is in fluid communication with a second conduit 78b and associated second fluid outlet 81. The second fluid outlet 81 is provided proximal to the first fluid outlet 80 and preferably directed or angled toward a flow path for fluid exiting the first fluid outlet 80 such that when fluids are simultaneously ejected from the first fluid outlet 80 and the second fluid outlet 81, the fluids are allowed to combine or mix at a location just outside of or downstream of the outlets. It is contemplated that at least a first fluid may be ejected from the device 70 without also ejecting a fluid or chemical from the fluid storage container 82. Accordingly, the second fluid outlet 81 is preferably located and positioned such that it does not obstruct a flow of the first fluid.

As further shown in FIG. 5, the fluid storage container 82 comprises a fill port 84 for adding or emptying a fluid to the container 82. Additionally, a gauge 86 is provided to indicate the remaining contents or fill-level of the container 82. In order to pressurize internal contents of the fluid storage container 82 and enable dispensation of the contents of the container, a hand operated compression air pump 88 is used to pressurize the chemical contained within tank 82. The pump 88 provides means of forcing the chemical through the second fluid conduit 78b and through the second fluid outlet 81 directly into fluid exiting the first fluid outlet 80. Various hand-operated pumps, including but not limited to those described in U.S. Pat. No. 4,591,071 to Johnson are contemplated for use with various embodiments of the present disclosure.

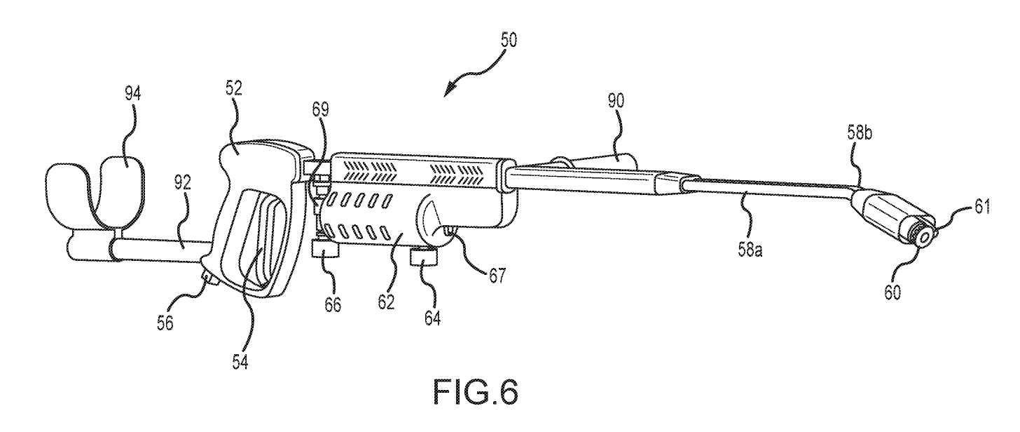

FIG. 6 is a perspective view of a dispensing wand 50 according to one embodiment of the present disclosure. As shown, the dispensing wand 50 comprises a shut off gun portion 52 including a trigger 54 and a fluid inlet 56. The trigger 54 is operable to selectively dispense a fluid from the fluid inlet 56 through an elongate conduit 58a and a first fluid outlet 60. The first fluid outlet 60 may comprise various different nozzles based on a desired application. The dispensing wand 50 according to various embodiments further comprises a fluid storage container 62 for containment of a fluid or chemical, such as those useful in cleaning operations. The fluid storage container 62 comprises pressurization means such as an internal piston that is actuated by water pressure from the shut off gun which forces the chemical in the container out through the elongate conduit 58b and the second fluid outlet 61 into the high pressure spray exiting at the outlet portion 60. Fluids are preferably mixed downstream of both of the fluid exits 60, 61. The system thus provides for an efficient means for injecting a chemical into a fluid flow and quick transitioning from a “rinse” (e.g. water only) to a “soap” (e.g. water and chemical combination) operation or mode of use. The embodiment of FIG. 6 further prevents or avoids contact between a cleaning chemical and a pump or coil of a system (not shown in FIG. 6). Chemicals may be applied and dispensed under high or low pressure operations.

The device 50 of the embodiment of FIG. 6 comprises a fluid flow path 69 for directing a fluid from the first fluid inlet 56 into an internal volume of the fluid storage container in order to activate a piston or otherwise pressurize contents of the fluid storage container to eject the same from the second fluid outlet 61. Fluid flow through the path 69 is controlled by a valve 66 which is accessible to a user and preferably manually-adjustable. Operation of the valve 66 controls an amount of fluid to be diverted from the first fluid conduit 58a into the internal volume of the fluid storage container 62. The valve 66 is operable to substantially shut off fluid flow from the first fluid inlet 56 to the storage container 62. In such a position, contents of the fluid storage container 62 are maintained within the container 62. Such a valve position may result in and correspond to a “rinsing” operation or position of use wherein fluid (e.g. water) is ejected through the fluid outlet 60 without the addition or additional dispensation of chemicals or contents from the fluid storage container 62. A dispensation of fluid contents from the storage container 62 is activated by an opening of the valve 66. The valve 66 may be opened to varying degrees to selectively alter a pressure being applied in an internal volume of the container 62, and thereby regulate or vary the flow of a fluid from the second fluid outlet 61.

The device 50 of FIG. 6 further comprises ergonomic features to enable comfortable control and operation of the device 50. For example, the device comprises a side handle 90 which may comprise a grip for a user's hand. Additionally, an arm cradle 94 is provided and extends from proximal or user-end of the device. As shown, an extension 92 is provided with an arm cradle 94 positioned on a proximal end thereof such that at least a portion of the weight of the device 50 may be supported by a user's forearm (for example). The ergonomic features of FIG. 6 may be provided on various embodiments and devices disclosed herein and are not limited to the embodiment depicted in FIG. 6. Additionally, these features 90, 92, 94 are contemplated as comprising removable components in various embodiments such that a user may apply and remove such features based on preference.

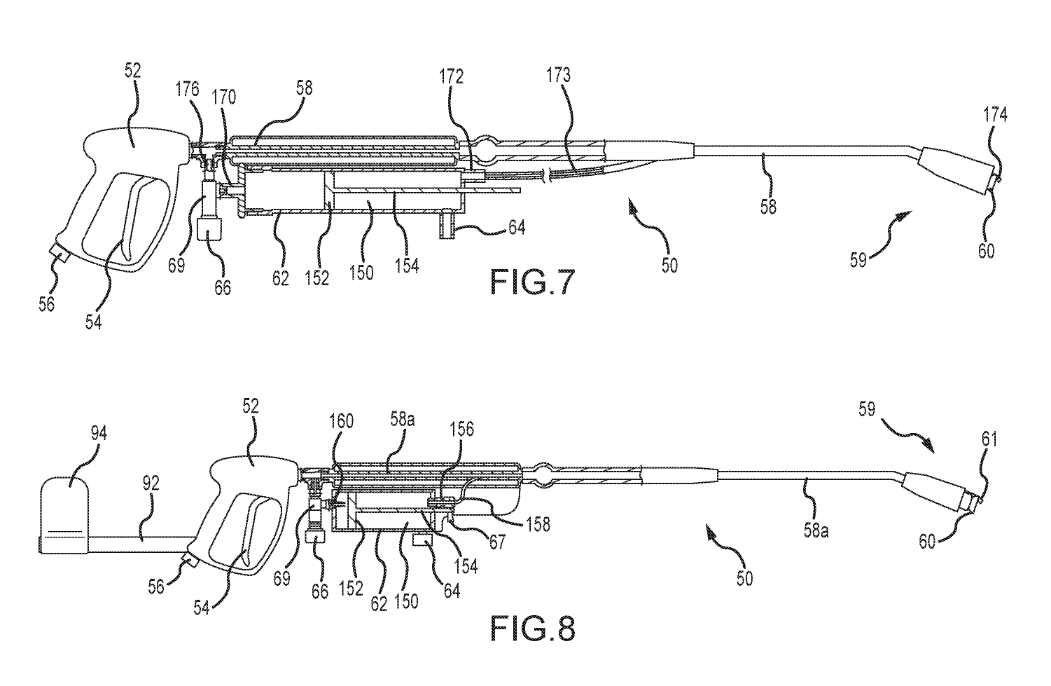

FIG. 7 is a cross-sectional elevation view of the fluid dispensing device 50 according to one embodiment of the present disclosure. As shown, the device 50 comprises a spray gun with known features including a handle portion 52, a trigger 54, and a first fluid inlet 56. The device comprises an outlet portion 59 at a distal end of the device for dispensing fluids. At least one conduit 58 extends from the handle portion 52 to the outlet portion 59. In the depicted embodiments, the conduit 58 comprises an elongate conduit for conveying pressurized fluids to the distal end of the device. In alternative embodiments, and as shown and described herein, a plurality of parallel extending conduits are provided wherein one of the conduits comprises a higher pressure line than the adjacent and/or parallel conduit. In such an arrangement, a user may selectively switch between use of either conduit based on a desired dispensing pressure. Different nozzle arrangements may be provided on the distal ends of each of the conduits, such that manually removing and replacing nozzles is rendered unnecessary and a user may choose between dispensing nozzles by selecting one of the two conduits.

Referring to FIG. 7, the device 50 comprises a fluid storage tank 62 for storing and selectively dispensing a fluid. In various embodiments and preferred uses of the device, the fluid comprises a concentrated or ultra-concentrated cleaning fluid that is intended to be mixed with another fluid (e.g. water) to aid in cleaning operations. Such concentrated and ultra-concentrated cleaning fluids will be recognized by one of ordinary skill in the art, and no limitation with respect to such types of fluids is provided herewith. The fluid storage tank 62 comprises an internal volume 150, and a primary inlet 64 for enabling ingress and egress of fluid. The device 50 further comprises means for pressurizing the fluid storage container 62. In the depicted embodiment, a fluid inlet 56 is adapted to receive a pressurized fluid, such as a pressurized volume of water from a connected pressure washer (not shown in FIG. 7). The fluid inlet 56 and associated fluid are in communication with the conduit 58 for spraying and dispensing the fluid. Additionally, the fluid storage container 62 is in selective fluid communication with the fluid inlet 56. Specifically, a coupling 176 is provided at a proximal end of the conduit 58. The coupling 176 extends to a fluid bypass 69 which is in selective fluid communication with the fluid storage container 62 by way of a connection 170. The flow of fluid from the fluid inlet 56, and the flow-rate and pressure thereof, to the container 62 is selectively controlled by a valve 66. Manual adjustment of the valve controls the amount of fluid diverted from the conduit 58 to the container 62. The container 62 comprises a piston including a piston head 152 and a piston rod 154. A proximal side of the piston head 152 is impacted by a force from fluid diverted into the container 62, and a distal side of the piston head 152 applies the force to the fluid stored within the internal volume 154. Fluid is thereby compressed out of the internal volume 154 and allowed to flow through the storage container outlet 172. As shown in the embodiment depicted in FIG. 7, the outlet 172 comprises a conduit 173 that conveys the fluid to an outlet 174. Fluid that exits the outlet 174 is directed into an additional flow of fluid from the primary outlet 60. The fluids are thus allowed to mix upon exiting the device 50, or shortly thereafter. The conduit 173 may comprise conduits of various materials and properties. In certain embodiments, it is contemplated that the conduit 173 for conveying fluids from the storage container 62 comprises a flexible hose that may be attached to or wrapped around the device 50 or conduit 58. In alternative embodiments, the conduit 173 comprises a metal piping member that extends adjacent and/or parallel to the conduit 58.

In various embodiments, it is contemplated that the fluid storage container 62 comprises an add-on or attachment feature that is selectively attached to a known or pre-existing spray gun or wand. In FIG. 7, the container 62 is selectively attachable to the spray gun by means of the coupling 176, which preferably comprises a threaded connection. Additionally, the fluid conduit 173 associated with the container 62 comprises a flexible container that may be adapted to fit any number of devices. The conduit 173 may also be cut to fit various different lengths of pre-existing devices.

FIG. 8 is a cross-sectional elevation view of the fluid dispensing device 50 according to one embodiment. The device 50 comprises various features shown and described in FIGS. 6-7. Additionally, the fluid storage container 62 comprises an internal volume 150 for storing a quantity of fluid. The fluid is preferably a concentrated or ultra-concentrated cleaning solution intended to be mixed with water or similarly diluted. The device further comprises a piston including a piston head 152 and a piston rod 154. The piston rod 154 may comprise an indicia 67 as shown and described herein and wherein the indicia 67 extends outside of the fluid storage container 62 and is operable to indicate a fill level of the container 62 to a user. The device comprises a valve 66 to control an amount of fluid directed from the first fluid inlet 56 through a fluid flow path 69. The fluid flow path 69 generally comprises a diversion from a primary flow of a first fluid through the device. In the depicted embodiment, for example, fluid that would otherwise be directed through the first fluid conduit 58a is directed through the fluid flow path 69 to pressurize contents of the fluid storage container 62. The fluid flow path 69 is associated with and in fluid communication with the fluid storage container 62 by way of a coupling 160 for sealingly directing fluid into an internal volume of the container 62. The fluid and/or pressure are applied to a proximal side of the piston head 152. A distal side of the piston head 152 thus transfers a force to the fluid stored in the internal volume 150. The contents of the internal volume 150 are thus forced out of an exit coupling 156 and a fluid conduit 158. The contents of the internal volume preferably travel through the exit coupling 156 and ultimately exit through the secondary outlet 61 to be mixed with at least one fluid exiting the first fluid outlet 60. In the embodiment of FIG. 8, the fluid conduit 158 extends along a length first conduit 58a and the fluid conduit 158 comprises a termination at the secondary outlet 61. In alternative embodiments, however, it is contemplated that the fluid conduit 158 is in fluid communication with the flow path of the first fluid conduit 58a such that fluid from the fluid storage container 62 is injected into or entrained in a fluid flowing through the first fluid conduit 58a prior to exiting the gun.

In various embodiments, the internal volume of the fluid storage container comprises a volume of between approximately 2 and 50 fluid ounces. In preferred embodiments, the internal volume of the fluid storage container comprises a volume of between approximately 8 and 24 fluid ounces. In certain preferred embodiments, the fluid storage container comprises a volume of approximately 16 ounces. It will be recognized, however, that the specific size and shape of the fluid storage container is not a critical aspect of the present disclosure and various volume, shapes, sizes, etc. are contemplated.

In various embodiments, including the embodiment of FIG. 8, the fluid storage container 62 is refilled and reset by applying a force to the distal end of the piston rod 154. Fluid from the coupling 160 that was inserted into the container 62 to force chemicals or other contents out through the outlet coupling 156 are thereby ejected from the container 62, and the internal volume 150 may be refilled with a chemical by use of the inlet 64.

The valve 66 is provided to selectively control and adjust an amount of fluid and pressure applied to the internal volume 150 of the container 62. The valve 66 may comprise any one of a number of valves as will be recognized by one of ordinary skill in the art. For example, the valve 66 may comprise a globe valve, a ball valve, a gate valve, a diaphragm valve, and/or various other manual valves suitable for control fluid flow from the first inlet 56 to the fluid storage container 62.

Manual adjustment of the valve 66 provides for selective control of dispensation of contents from the fluid storage container 62. One benefit of embodiments of the present disclosure is thereby provided in that a user may easily select or switch between a rinse operation comprising only water-dispensation to a mixing operation comprising a combination of water and cleaning fluids from the gun. Such conversation may be performed by operating features provided on the gun as shown and described herein, and a user need not return a distally located pressure washer or similar device to make such changes. Cleaning operations are thereby rendered more efficient and user-friendly.

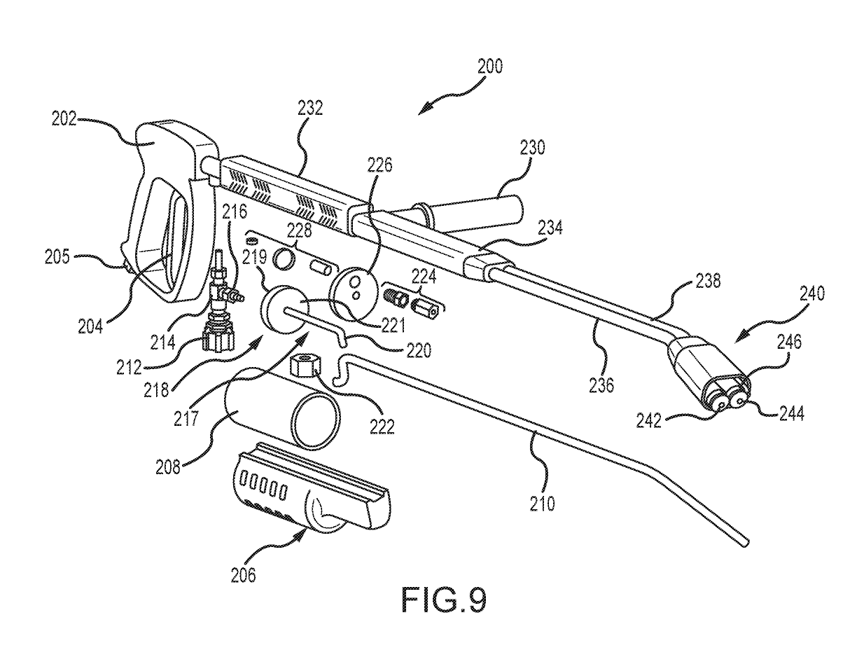

FIG. 9 is an exploded perspective view of one embodiment of the present disclosure. As show, a fluid dispensing device 200 is provided. The device 200 is adapted to dispense and direct at least one fluid and further comprises means for storing and dispensing at least a second fluid such as a chemical additive or concentrate. The device comprises a spray gun with a handle portion 202 and a trigger 204. The trigger 204 is operable to selectively dispense a first fluid from a first fluid inlet 205. The first fluid is ultimately ejected or sprayed from a distal end 240 of the device 200 as shown and described herein. The device 200 comprises at least one conduit 236 extending between the first inlet 205 and the distal end 240. In the depicted embodiment, the device 200 comprises a first conduit 236 and a second conduit 238 for conveying fluid from the first inlet 205 to the distal end 240. The first 236 and second 238 conduits provide a variable pressure wand or lance wherein a user may select at least one of the first conduit 236 and the second conduit 238 to convey and dispense fluid. The conduits 236, 238 comprise at least one of a different flow rate and/or a different nozzle provided on the distal end thereof such that a user's selection of one of the conduits 236, 238 results in different dispensation characteristics. As shown, the device 200 further comprises a second handle 230 for grasping by a user and to enable easier and more user-friendly operation of the device 200. In certain embodiments, manipulation of the second handle 230 is operable to select at least one of the conduits 236, 238 and operate a valve to selectively direct fluid from the inlet 205 to the distal end 240.

The device 200 of FIG. 9 further comprises a fluid storage container 206 adapted to store and selectively dispense a fluid. The fluid storage container 206 and its various components are shown in an exploded view in FIG. 9 for illustrative purposes and described in more detail below. The fluid storage container 206 of the depicted embodiment comprises a cylinder 208 that at least partially defines an internal volume of the fluid storage container 206. The device further comprises a piston 217 including a piston head 218 and a piston rod 220. The piston 217 is operable to displace a fluid from the cylinder 208. An end cap 226 is provided on a distal end of the cylinder 208, and the end cap comprises an outlet coupling 224. The coupling 224 comprises an outlet for fluid from the cylinder 208 and is in fluid communication with a conduit 210 for conveying fluid to a distal end 240 of the device 200. In order to actuate the piston 217, a valve assembly 212 is provided. The valve assembly comprises a fluid flow path for directing a portion of fluid from the first inlet 205 to an internal volume of the cylinder. The fluid and associated pressure provides a force to a proximal side 219 of the piston head 218. The distal side 221 of the piston head 218 thus compresses a fluid provided in the cylinder and forces said fluid through the outlet coupling 224. The valve assembly 212 comprises a manually adjustable valve to selectively vary the amount of fluid applied to the cylinder through an inlet coupling 216. The inlet coupling 216 is preferably secured to the container 206 by gaskets 228 and a fastener 222, or various other suitable devices as will be recognized by one of ordinary skill in the art. The piston rod 220 preferably comprises a distal end that extends from the cylinder 208 and the container 206.

The distal end 240 of the device 200 comprises a dispensing end. As shown in FIG. 9, each of the conduits 236, 238 for clean water comprise outlets 242, 244 or similar features to dispense and spray liquids. An outlet 246 of the conduit 210 that extends from the fluid storage container 206 is also provided. As shown, each of the outlets 242, 244, 246 are provided as separate outlets and mixing of fluids is allowed to occur after respective fluids have exited the device 200. The outlet 246 of the conduit 210 for the storage container 206 is preferably angled or directed toward a fluid flow path of the additional outlets 242, 244 such that fluids are mixed or entrained upon exit from the device or shortly thereafter.

Although various components and features may be described herein with respect to a particular embodiment, such features are contemplated as being provided or combined with any number of embodiments disclosed herein. For example, certain features disclosed and discussed with respect to any one or more of the devices in FIGS. 4-9 may be combined with or substituted with features of any one or more of the other devices provided in FIGS. 4-9.

While various embodiments of the present disclosure have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items.

What is claimed is:

1. A spray gun for dispensing a fluid, the spray gun comprising:
a first fluid inlet operable to receive a supply of first fluid from a source;
a first fluid outlet operable to dispense the first fluid from the gun;
a first fluid conduit extending between the first fluid inlet and the first fluid outlet and at least partially defining a fluid flow path;
a valve provided in a fluid flow path between the first fluid inlet and the first fluid outlet, the valve being operable to selectively prevent a fluid from exiting the first fluid outlet;
a first trigger interconnected to and operable to activate the valve;
a fluid storage container comprising an internal volume, a second fluid inlet and a piston, the piston being operable to apply a pressure to a stored fluid provided within the internal volume and to dispense the stored fluid through the second fluid outlet;
a second fluid conduit extending from the internal volume and comprising a second fluid outlet, the second fluid outlet provided proximal to the first fluid outlet and operable to dispense the stored fluid into the first fluid after the first fluid has exited the first fluid outlet and such that the stored fluid is entrained with the first fluid to aid in cleaning operations.

2. The spray gun of claim 1, wherein the second fluid inlet comprises a fill port for the fluid storage container.

3. The spray gun of claim 1, wherein the fluid storage container comprises a second valve to control a flow of fluid exiting the fluid storage container.

4. The spray gun of claim 1, wherein the fluid storage container comprises a gauge to indicate a fill-level of the fluid storage container.

5. The spray gun of claim 1, further comprising a hand-operated pump operable to pressurize at least one of the internal volume and a fluid provided within the internal volume of the fluid storage container.

6. The spray gun of claim 1, wherein the fluid conduit comprises a Venturi tube operable to draw fluid from the fluid storage container into the fluid flow path.

7. The spray gun of claim 1, wherein the fluid storage container comprises a spring-biased piston operable to pressurize the stored fluid.

8. A spray gun for dispensing a fluid, the spray gun comprising:
a first fluid inlet operable to receive a supply of first fluid from a source;
a first fluid outlet operable to dispense the first fluid from the gun;
a fluid conduit extending between the first fluid inlet and the first fluid outlet and at least partially defining a fluid flow path;
a valve provided in a fluid flow path between the first fluid inlet and the first fluid outlet, the valve being operable to selectively prevent a fluid from exiting the first fluid outlet;
a first trigger interconnected to and operable to activate the valve;
a fluid storage container secured to the spray gun, the fluid storage container comprising an internal volume, a second fluid inlet, a second fluid outlet, wherein the spray gun is operable to apply a pressure to a stored fluid provided within the internal volume and to dispense the stored fluid through the second fluid outlet;
wherein the second fluid outlet is operable to selectively dispense a fluid from the fluid storage container to be entrained with the supply of first fluid.

9. The spray gun of claim 8, wherein the second fluid outlet is provided proximal to the first fluid outlet, and wherein the second fluid outlet is operable to inject a fluid into the first fluid after the first fluid has exited the first fluid outlet.

10. The spray gun of claim 8, wherein the second fluid outlet is provided in the fluid flow path.

11. The spray gun of claim 8, wherein the stored fluid is provided in at least one of a bag and a bladder provided within the fluid storage container.

12. The spray gun of claim 11, wherein the first fluid applies a pressure to the at least one of a bag and a bladder to pressurize the stored fluid.

13. The spray gun of claim 11, wherein the at least one of a bag and a bladder is replaceable.

14. The spray gun of claim 8, wherein the fluid storage container comprises pump to pressurize the stored fluid.

15. A wand for dispensing a fluid, the wand comprising:
a first fluid inlet operable to receive a supply of first fluid from a source;
a first fluid outlet operable to dispense the first fluid from the gun;
a first fluid conduit extending between the first fluid inlet and the first fluid outlet and at least partially defining a fluid flow path;
a valve provided in a fluid flow path between the first fluid inlet and the first fluid outlet, the valve being operable to selectively prevent a fluid from exiting the first fluid outlet;
a first trigger interconnected to and operable to activate the valve;
a fluid storage container secured to the wand, the fluid storage container comprising an internal volume, a second fluid inlet, a second fluid outlet, and a second fluid conduit extending between the second fluid inlet and the second fluid outlet;
wherein the second fluid conduit is operable to selectively dispense a fluid from the fluid storage container to be entrained with the supply of first fluid.

16. The wand of claim 15, wherein second fluid outlet is provided proximal to the first fluid outlet, and the first fluid and the stored fluid are mixed after exiting the wand.

17. The wand of claim 15, wherein the second fluid outlet is provided within the fluid flow path.

18. The wand of claim 15, wherein the fluid storage container comprises a hand-operated pump to pressurize the fluid storage container.

19. The wand of claim 15, wherein the fluid storage container comprises a volume of between approximately 10 and 20 ounces.

20. The wand of claim 15, wherein the first fluid comprises pressurized water and the stored fluid comprises a concentrated cleaning agent.
